(19) United States
(12) Patent Application Publication
(10) Pub. No.: US 2018/0286277 A1
(43) Pub. Date: Oct. 4, 2018

(54) SYSTEM AND METHODOLOGY FOR REGULATING INSTRUCTIONAL MULTIMEDIA APPLICATIONS

(71) Applicant: Insy Shah, Dubai (AE)

(72) Inventor: Insy Shah, Dubai (AE)

(21) Appl. No.: 15/936,728

(22) Filed: Mar. 27, 2018

(30) Foreign Application Priority Data
Mar. 28, 2017 (IN) 201711010968

(51) Int. Cl. G09B 19/00; G06F 9/451; G09B 5/06; G06F 3/0481

(52) U.S. Cl. CPC G09B 19/0092; G06F 3/0481; G09B 5/065; G06F 9/453

(57) ABSTRACT

This invention relates system and methodology of regulating instructional multimedia applications. A system for regulating instructional multimedia applications comprising an interactive computer, the interactive computer having a user interface, and the interactive computer connected to a network, and a database of instructional multimedia applications in selective communication with the network; the interactive computer configured to selectively communicate with the database through the user interface to provide information to the user, the user interface configured to display instructional multimedia applications, wherein the user interface is configured to allow user to select kind of instructional multimedia application that user wants to view and divides the instructional multimedia application in defined segments that provides description to each section and to control speed of instructional multimedia application as per user's need.

### FIELD OF THE INVENTION

This invention relates system and methodology of regulating instructional multimedia applications. A system for regulating instructional multimedia applications comprising an interactive computer, the interactive computer having a user interface, and the interactive computer connected to a network, and a database of instructional multimedia applications in selective communication with the network; the interactive computer configured to selectively communicate with the database through the user interface to provide information to the user, the user interface configured to display instructional multimedia applications, wherein the user interface is configured to allow user to select kind of instructional multimedia application that user wants to view and divides the instructional multimedia application in defined segments that provides description to each section and to control speed of instructional multimedia application as per user's need.

### BACKGROUND

It is a common observation that it is highly difficult to use instructional video while watching and noting down the steps involved. For example using a recipe video to cook along with is difficult task and cannot be controlled, the user skips the steps and misses the chance of enjoying the cooking process by looking and holding the steps.

Some of the related prior arts are discusses herein below

US20120096087: it described system and method to allow home cooks and professional chefs with basic computer skills to create recipes with photo slideshows and videos, collect and organize recipes in electronic cookbooks that can be published and sold as eBooks. The new process incorporates methods for computing calories, nutritional facts and food group servings of recipes, and comparing and food group servings to recommended daily allowances.

U.S. Ser. No. 09/510,026: it describes methods and devices for generating a recipe for creating a clip. A recipe request can be received at a server, such as a recipe server. The recipe request may be related to a clip including audio and/or video. The server can generate a recipe for creating the clip using one or more slices of a data source. The recipe can include one or more tasks that can include a data-source task which can include a specification of the data source and slice definitions for the one or more slices. The data source can include a video and/or audio data source. A slice definition can include a slice value and a slice offset for locating a respective slice within the data source. The recipe can then be transmitted from the server.

US20100057229: Using the ReciPC concept allows users to do new and innovative things with recipes and instructional guides. Users are no longer limited to reading directions from a cookbook or instructions from a manual. Incorporating technological enhancements such as audio, scrolling text, video, and 3 Dimensional personalized training (holograms) gives manuals and cookbooks a modern day facelift. In addition, integrating media devices with the ReciPC into kitchen appliances and furniture will revolutionize how recipes or instructions are followed.

US20020171674: it describes a system and method for providing food-related information, including recipes, methods, hints and cooking instructions to a user via an interactive computer at a food-related location, such as a kitchen. The interactive computer includes a graphic-user interface (GUI) and one or more speakers, and the GUI is preferably a touch-screen capable of displaying interactive multimedia applications to the user, such as video cooking-step illustrations. The interactive computer alternately further includes a secondary storage device that provides food-related information to the user from a secondary storage media such as a CD-ROM or floppy disk.

U.S. Pat. No. 5,832,446: It discloses a computerized cooking instruction system. It provides a computerized, electronic cooking encyclopedia running on Sun SPARC stations. The computerized system and method provide a search tool for accessing information about a worldwide variety of foods and beverages. The program of the invention allows for searching recipes by culture, menu category, preparation method and ingredients. Information is provided about the degree of complexity, necessary equipment, cooking tips, any caveats proffered and restaurants that actually serve a given dish (along with their menus). The software includes accessing an extensive database having color illustrations. When a CD ROM video or audio library is accessed, animation and/or audio viewing and listening are made possible.

US20160381742: it discloses technologies for controlling a cooking appliance include receiving a cooking recipe from a computing device. The cooking recipe defines one or more cooking steps and each cooking step includes executable instructions that are executable by the cooking appliance to cause the cooking appliance to perform the associated cooking step. The cooking appliance may execute the instructions of each cooking step to perform the cooking recipe. The recipe may include digital rights management features, may be encrypted, and may include additional information such as an ingredient list. The cooking appliance may provide instructions, such as audible instructions, to a user while cooking the recipe. The user may also generate a cooking recipe using the cooking appliance and share the cooking recipe with other users.

However, there are still various drawbacks in existing technology and therefore there is need for system and methodology that allows more control over the instructional video. There is need for technology that gives the user more control to use instructions video along. Further there is need for technology that allows user to control the flow of view. There is also need for technology that provides an interactive medium or user interface to the instructional video.

The present invention is distinguished in such a manner from the previously invented concepts that the inventor is not slicing the clips or video to make separated clips, whereas the inventor are segmenting the video, keeping the original intact and wherein, the segmentation is done on the front end while displaying to the user in step. Hereto, in the process of the invention, the inventor is not touching the video, thereto dividing the recipe steps and the videos are playing in accordance with the respective description text and/or audio as well as ingredients.

These and other features, aspects and advantages of the present invention will become better understood with reference to the appending description and drawings.

### OBJECT OF THE INVENTION

The main object of the invention is to make the process more controllable by adding segments that gives the user more control to cook along.

The instant invention provides the following benefits:
a) The invention is to make the process more controllable by adding segments that gives the user more control to cook along.
b) The invention provides a section and each section will have picture, video, text, audio and ingredients needed for that particular step.
c) The process of simplifying a recipe by breaking it down into segments that the user can follow/execute/carry out and when done move on to the next step thereby helping to cook along with it.
d) The author defines the video segments.
e) The author defines the direction of use.
f) The user cannot control the speed of the video.
g) The video segmenting defined by the author do not affect the source of the video.
h) In the present invention, there is no additional clips are being generated from the segmentation.
i) In the present invention, the inventor is displaying the video in segments so that the user can perform the task and be ready for the next task.
j) Furthermore, the present invention is not slicing the clips or video to make separated clips, whereas the inventor are segmenting the video, keeping the original intact wherein, the segmentation is done on the front end while displaying to the user in step.
k) Hereto, in the process of the invention, the inventor is not touching the video, thereto dividing the recipe steps and the videos are playing in accordance with that.
l) This is a visual/audio replacement for cookbooks into the digital form.
m) This is an improvement over the known methods of processing video tutorials, in order to make them more user responsive by segmenting the video steps which can be easily watched, esp. by an inexperienced user.

### SUMMARY OF THE INVENTION

The present invention present hereto a process for creating steps to any recipe video by controlling the video to cook at own speed particularly replaying that portion of the video. The video comprises novel and unique features of adding process description to that part of the video and furthermore by adding ingredients to that part of the selected. The present invention submits very novel and inventive approach to look, play, add, save, describe and concurrently cook by controlling the video while running on the user interface. The video comprises a novel technology for the data processing, video data presentation and user interfaces of video players.

The process may comprise:
a) a display thumbnail image for each respective recipe.
b) a controller or control buttons for providing video data to display and described concisely
   each step has visual/picture/video
   each step has controls to play video step/portion video
   each page has text description/procedure to follow of a step displayed on the screen
   serving quantity for each cooking session can be changed and accordingly the ingredients required for the cooking step changes
   personal notes for each step can be added, saved, edited & deleted.

The present invention features the process of simplifying a recipe by breaking it down into segments that the user can follow or execute or carry out and when done move on to the next step thereby helping to cook along with it.

### Interpretation of the Terms

The following definitions and rules of the interpretation apply in this specification:

STREAMING: Streaming media is program (MULTIMEDIA) that is constantly received by and presented to an end-user while being delivered by a provider. Stream mentions to the process of transporting or gaining media in this manner; the term refers to the delivery method of the medium, rather than the medium itself, and is an alternative to file downloading, a process in which the end-user obtains the entire file for the content before watching or listening to it.

Automating: IT process automation (ITPA), also known as run book automation (RBA), is the ability to arranged and integrate tools, people and processes through workflow. Benefits of ITPA include: reduced human errors, faster response to mission-critical system problems and more efficient allocation of resources.

Navigation: Navigation is a field of study that focuses on the process of monitoring and controlling the movement of any portable object.

Features: a unique attribute or aspect of something.

Extraction: Information extraction (IE) is the task of automatically extracting structured information from unstructured and/or semi-structured machine-readable documents.

Fragmentation: the process or state of breaking or being broken into fragments.

Index Page is a powerful design feature available in certain templates. The Index Page collects images and content from different pages and arranges them visually, creating a single destination where visitors can browse content from multiple sub-pages.

Thumbnails are reduced-size versions of pictures or videos, used to help in recognizing and organizing them, serving the same role for images as a normal text index does for words.

Segments:—each of the parts into which something is or may be divided.

User: a person who uses or operates something.

Author: who writes a script, article, or document.

Clips a short part of a film or video:

Display: an electronic device for the visual presentation of data or images.

Task: In computer programming, a task is a basic unit of programming that an operating system controls. Depending on how the operating system defines a task in its design, this unit of programming may be an entire program or each successive invocation of a program.

### BRIEF DESCRIPTION OF THE DRAWINGS

The method and process are presented hereto by means of example embodiments on a drawing, in which:

FIG. 1, shows the recipe detail screen.

FIG. 2, Shows the recipe detail display of cooking steps.

FIG. 3, shows front end of the whole process from search to rating

FIG. 4, shows process of display of segments in front end (user interface).

### DETAILED DESCRIPTION OF THE INVENTION

The present invention present hereto a process for creating steps to any recipe video by controlling the video to cook at own speed by segmenting and adding description, text, audio along with the ingredients. The video comprise novel and unique features of adding process description to that part of the video and furthermore by adding ingredients to that part of the selected. The present invention submits very novel and inventive approach to look, play, add, save, describe and concurrently cook by controlling the video while running on the user interface. The video comprises a novel technology for the data processing, video data presentation and user interfaces of video players.

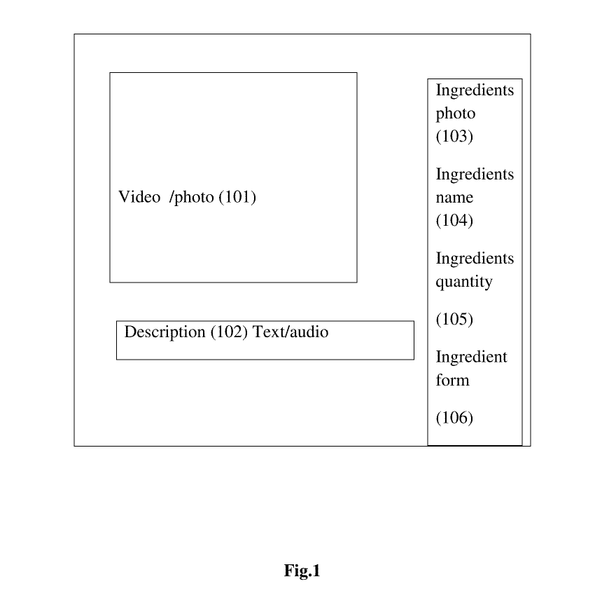

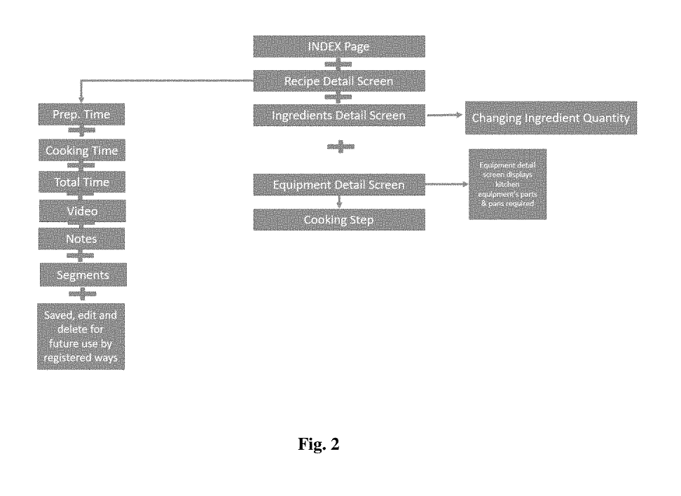

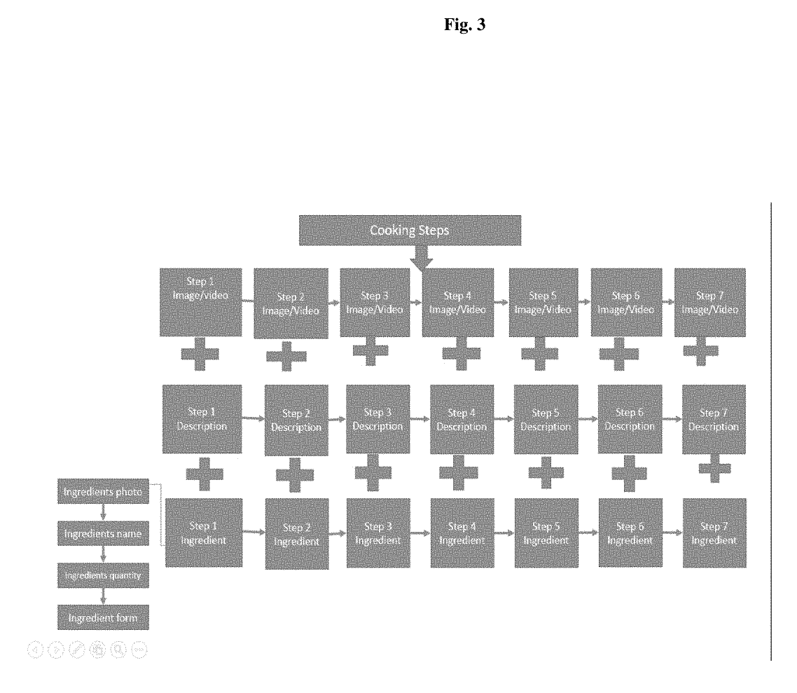

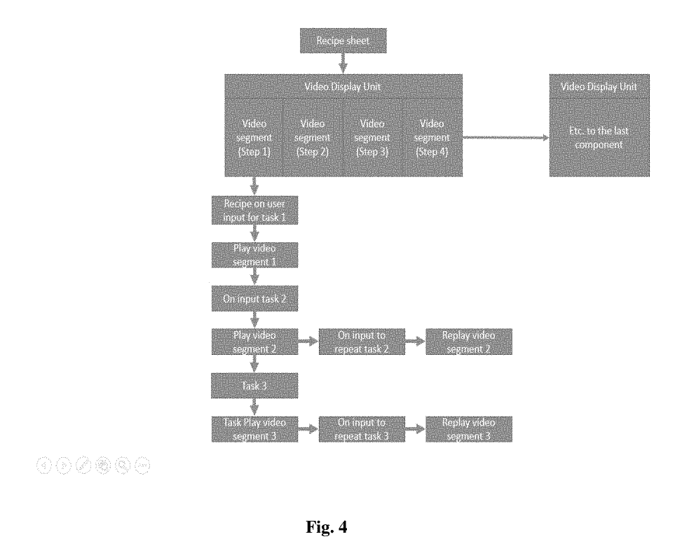

FIG. 1, illustrates, as an example wherein present invention is employed in relation to receive instruction video. All recipes have a displayed thumbnail image for each respective video. The thumbnail possess a varied information on each recipe e.g. recipe name rating, total cooking time etc. are displayed properly. Similarly, FIG. 2, shows recipe detail page wherein each recipe's detailed information is given on the displayed page. The details as described in the accounts comprises, preparation time, cooking time, total time, chef name, rating by users, ingredients required etc. FIG. 3, depicts ingredients detail screen wherein the screen displays the name of the ingredient required, quantity required to cook the dish and the form in which it should be used to cook the dish all detailed description is submitted as an example on the figure. The FIG. 3 depicts unique way for setting the ingredient quantity as per the serving setting of the page. FIG. 4, shows changes in the ingredients quantity when the user changes the number of people he is cooking for. The invention presents that the quantity is set as per the serving setting of the page or interface. FIG. 5, represents equipment detail screen displays kitchen equipment pots & pans required.

The purpose of the recipe video is to make the process more controllable by adding segments that gives the user more control and under the grip to cook along with watching the video. Furthermore, each section possesses a picture, video and also ingredients needed for that particular step in recipe video. The author defines the video segments. The author defines the direction of use. The user cannot control the speed of the video. The video segmenting defined by the author do not affect the source of the video. In the present invention, there is no additional clips being generated from the segmentation. In the present invention, the inventor is displaying the video in segments so that the user can perform the task and be ready for the next task.

More particularly, the present invention is not slicing the clips or video to make separated clips, whereas the inventor is segmenting the video, keeping the original intact wherein, the segmentation is done on the front end while displaying to the user in steps.

Hereto, in the process of the invention, the inventor is not touching the original video, thereto dividing the recipe steps and the videos are playing in accordance with that. This is a visual/audio replacement for cookbooks into the digital form. This is an improvement over the known methods of processing video tutorials, in order to make them more user responsive by segmenting the video steps which can be easily watched, esp. by an inexperienced user.

The process of simplifying a recipe by breaking it down into the segments comprise an Index or Thumbnail page on the recipe pages. The Index Page is a powerful design feature available in certain templates. The Index Page collects images and content from different pages and arranges them visually, creating a single destination where visitors can browse content from multiple sub-pages. Thumbnails are reduced-size versions of pictures or videos, used to help in recognizing and organizing them, serving the same role for images as a normal text index does for words. The information on each recipe e.g. recipe name rating, total cooking time etc. are displayed on the index page.

### Setting an Example to Understand Better

The inventor presents following set of examples to support his novel invention also presenting herein below a chart table for the better understanding:

Each recipe's detailed information which is presented on the index page. The information on the “Recipe detail page—part 1” comprise preparation time, cooking time, total time, chef name, rating by users, ingredients required etc. The page also present links to the video and links to step by step layout thereto itself.

Further, the detail page on the index shows—“Recipe Detail Page—part 2”—which displays the name of the ingredient required, quantity required to cook the dish and the form in which it should be used to cook the dish. There to on the same page quantity is set as per the serving setting of the page.

The invention describes “Recipe Detail Page—part-3”—comprise cooking steps which says that each page has details of a step displayed on the screen. The details include the procedure to follow for the step. The invention describes in the step 1 serving quantity for each cooking session which can be changed and accordingly the ingredients required for the cooking step changes. Likewise, personal Notes for each step can be added, saved, edited and deleted.

The feature of showing each step as a segment of the video recipe, a page at a time with ingredients photo, ingredient name, ingredient quantity and ingredient form along with description text/audio for each step is unique and novel and requires patent protection. This step includes changing of quantities feature which enables changes on all the slides/pages

Moreover, in the later stage the page of the invention displays cooking steps-change serving procedure, wherein the quantity involved in a particular recipe, the user wishes to cook can be changed, which in turn changes all the ingredient quantity. The details include a photo for each step and text description of the procedure to follow for that recipe. The personal notes for each step can also be added, saved, edited and deleted hereto as well.

Further, in the cooking step-2 user interface shows a visual in the form of photo or video segment of what is to be done, along with text/audio describing the action. The ingredients required for each step is shown on the screen along with a photo of the ingredient, quantity and the form in which it should be used. The personal notes for each step can also be added, saved, edited and deleted hereto as well.

Following, the step-3 user interface shows a visual in the form of photo or video segment of what is to be done, along with text describing the action. The ingredients required for each step is shown on the screen along with a photo of the ingredient, quantity and the form in which it should be used. The personal notes for each step can also be added, saved, edited and deleted hereto as well.

Subsequently, the step-4-7 user interface shows a photo/video of what is to be done, along with text describing the action. The ingredients required for each step is shown on the screen along with a photo of the ingredient, quantity and the form in which it should be used. The personal notes for each step can also be added, saved, edited and deleted hereto as well.

Later on, the step-8-11 the interface shows a photo/video of what is to be done, along with text describing the action which repeats for every step with no minimum or maximum no of steps prescribed. The ingredients required for each step is shown on the screen along with a photo of the ingredient, quantity and the form in which it should be used. The personal notes for each step can also be added, saved, edited and deleted hereto as well.

Consequently, the cooking steps—Last screen of the user interface shows a photo/video of the final finished dish along what it can be served with, garnish suggestions etc. The personal notes for each step can also be added, saved, edited and deleted hereto as well.

The feature of showing each step of a segmented video recipe, a page at a time with ingredients photo, ingredient name, ingredient quantity and ingredient form and description text/audio for each step is unique and novel and requires patent protection. This step includes changing of quantities feature which enables changes on all the slides.

Each page has details of a step displayed on the screen, wherein the details include the procedure to follow for the step, also serving quantity for each cooking session can be changed and accordingly the ingredients required for the cooking step changes. The personal notes for each step can also be added, saved, edited and deleted hereto as well.

Chart Table as an Example

Displaying directions to start cooking- Orange Cheese Cake
Orange Cheese Cake Step-1-The Ingredients Quantity
Orange Cheese Cake Step 1(a) - Change Serving-Change Ingredients
Quantity to serve
Orange Cheese Cake Step 1(c) - Change serving setting as per the
user's serving requirement prior to start cooking
Orange Cheese Cake Step 2- Crumble the biscuits by putting in a plastic
bag and using the rolling pin or with a food processor.
Orange Cheese Cake Step 3-Add melted unsalted butter and mix together
to combine well.
Cooking steps-4-7 user interface shows a photo what is to be done, along
with text describing the action
Cooking steps-8-11 user interface shows a photo what is to be done,
along with text describing the action which repeats for every step with no
minimum or maximum no. of steps prescribed.
The final step-Orange Cheese Cake is ready. Last Screen showing final
finished dish. Enjoy!!!

The chart showing the cooking steps of what is to be done, along with text describing the action which repeats for every step with no minimum or maximum no of steps prescribed. The ingredients required for each step is shown on the screen along with a photo of the ingredient, quantity and the form in which it should be used. The personal notes for each step can also be added, saved, edited and deleted hereto as well.

The present invention is not limited to the above-described embodiments, and various alterations, modifications, and/or alternative applications of the invention may be possible, if desired, without departing from the scope and sprit of the invention, which can be read from the claims and the entire specification. All these possible alterations, modifications, and/or alternative applications of the invention are also intended to be within technical scope of the present invention. The invention is also not limited to Drawings as described in the specification but elements such as video, image, text, audio and ingredients can be presented in the various manner.

This application claims priority benefit of Indian Patent Application no. 201711010968, filed Mar. 28, 2017, which application is incorporated herein by reference in its entirety.

1. A system for regulating instructional multimedia applications comprising an interactive computer, the interactive computer having a user interface, and the interactive computer connected to a network, and a database of instructional multimedia applications in selective communication with the network; the interactive computer configured to selectively communicate with the database through the user interface to provide information to the user, the user interface configured to display instructional multimedia applications, wherein the user interface (the front end) is configured to allow user to select kind of instructional multimedia application that user wants to view and divides the instructional multimedia application in defined segments that provides description to each segment as per user's need.

2. The system as claimed in claim 1, wherein user interface video, photo, text/audio ingredient can be displayed in any order.

3. The system as claimed in claim 1, wherein the system allows segmentation of the instructional multimedia application.

4. The system as claimed in claim 3, wherein the segmentation is defined by the author of the instructional multimedia application including directions to use.

5. The system as claimed in claim 3, wherein the system does not allow segmentation to affect the source of the instructional multimedia application.

6. The system as claimed in claim 3, wherein the system does not allow user to control the source of the instructional multimedia application.

7. The system as claimed in claim 3, wherein user interface allows displaying of the instructional multimedia application in segments to enable user to perform the task and be ready for the next step involved in the task.

8. The system as claimed in claim 3, wherein the segmentation is being done on the front end, while displaying to the user instep form.

9. The system as claimed in claim 1, wherein the clips or interactive multimedia application are not being sliced to make separate clip wherein the instructional multimedia application is being segmented by keeping the interactive multimedia application intact.

10. The system as claimed in claim 1, wherein the system includes a touch-screen interface on the user interface.

11. The system as claimed in claim 1, wherein the system includes audio on the user interface.

12. A method for regulating instructional multimedia applications comprising the steps of
Providing an interactive computer having a user interface;
Connecting the interactive computer to a network with a database of instructional multimedia applications;
Configuring the interactive computer to selectively communicate with the database through the user interface to provide information to the user; Displaying instructional multimedia applications on the user interface; and Configuring the user interface to allow user to select kind of instructional multimedia application that user wants to view, to divide the instructional multimedia application in defined segments that provides description to each segment as per user's need.

13. The method as claimed in claim 12, wherein the instructional multimedia application is segmented.

14. The method as claimed in claim 13, wherein the segmentation is defined by the author of the instructional multimedia application including directions to use.

15. The method as claimed in claim 13, wherein the segmentation does not affect the source of the instructional multimedia application.

16. The method as claimed in claim 12, wherein the instructional multimedia application is displayed in segments to enable user to perform the task and be ready for the next step involved in the task.

17. The method as claimed in claim 12, wherein the segmentation is being done on the front end, while displaying to the user instep form.

18. The method as claimed in claim 12, wherein the clips or interactive multimedia application are not being sliced to make separate clip wherein the instructional multimedia application is being segmented by keeping the interactive multimedia application intact.

19. The method as claimed in claim 12, wherein the interactive computer includes a touch-screen interface on the user interface.

20. The method as claimed in claim 12, wherein the interactive computer includes audio on the user interface.
